(19) United States
(12) Patent Application Publication
(10) Pub. No.: US 2025/0093479 A1
(43) Pub. Date: Mar. 20, 2025

(54) DOPPLER LiDAR APPARATUS USING MULTIPLE WAVELENGTH LASER

(71) Applicant: Lambda innoVision Inc., Hwaseong-si Gyeonggi-do (KR)

(72) Inventors: Jong Pil LA, Hwaseong-si Gyeonggi-do (KR); Ji Eun CHOI, Hwaseong-si Gyeonggi-do (KR)

(73) Assignee: Lambda innoVision Inc., Hwaseong-si Gyeonggi-do (KR)

(21) Appl. No.: 18/616,292

(22) Filed: Mar. 26, 2024

(30) Foreign Application Priority Data
Sep. 20, 2023 (KR) 10-2023-0125317
Sep. 20, 2023 (KR) 10-2023-0125349
Nov. 20, 2023 (KR) 10-2023-0160212

(51) Int. Cl. G01S 7/4911; G01S 7/481; G01S 7/4912; G01S 17/58

(52) U.S. Cl. CPC G01S 7/4911; G01S 7/4811; G01S 7/4917; G01S 17/58

(57) ABSTRACT

Disclosed is a Doppler LiDAR apparatus using a plurality of wavelength lasers. The Doppler LiDAR apparatus may include a plurality of light sources each configured to output light for detecting the speed of a target and the directivity of a moving target, an optical system configured to adjust the path or state of light to be output to the outside or reflected light that is reflected by the target, an interferometer configured to make the light that is output by any one of the plurality of light sources and the reflected light that has passed through the optical system interfere with each other, and a detection unit configured to detect information on the distance and speed of the target by receiving the light that has been subjected to interference in the interferometer.

### CROSS-REFERENCE TO RELATED APPLICATIONS

The present application claims priority under 35 U.S.C. § 119 (a) to Korean Patent Application Nos. 10-2023-0125317 and 10-2023-0125349, filed in the Korean Intellectual Property Office on Sep. 20, 2023 and Korean Patent Application No. 10-2023-0160212, filed in the Korean Intellectual Property Office on Nov. 20, 2023, the entire disclosures of which are incorporated herein by reference.

These patents are the results of research that was carried out by the support (a unique project number: 2015187768, a detailed project number: 20024096, a project name: The development of volume 300 cc less-Solid State FMCW LiDAR for an autonomous robot for handling a poor indoor and outdoor driving environment (e.g., snow, smoke, or dust)) of the Korea Planning & Evaluation Institute of Industrial Technology by the finances of the government of the Republic of Korea (The Ministry of Trade, Industry and Energy) in 2023.

Furthermore, these patents are the results of research that was carried out by the support (a unique project number: 1425177505, a detailed project number: S3364883, a project name: the development of an ultra-small FMCW LiDAR sensor for an autonomous vehicle based on an optical semiconductor) of the Korea Technology and Information Promotion Agency by the finances of the government of the Republic of Korea (The Ministry of Small and Medium-sized Enterprises and Startups) in 2023.

### BACKGROUND

### 1. Technical Field

The present embodiment relates to an optical frequency stabilization apparatus based on a signal generator capable of being implemented at a low cost and a coherent LiDAR apparatus including the same.

### 2. Related Art

Contents described in this part merely provide background information of the present embodiment, and do not constitute a conventional technology.

Light Detection And Ranging (LIDAR) is a technology for detecting an object by using light and measuring a distance up to the object, and has been developed in a form in which topography data for constructing three-dimensional geographic information system (GIS) information are constructed and visualized and thus has been used in fields, such as construction and defense.

Recently, LiDAR has been in the spotlight as a core technology as LiDAR is applied to autonomous vehicles, mobile robots, and drones. If LiDAR is applied to an (autonomous driving) vehicle, LiDAR enables a vehicle that is being driven to measure the presence of another object or another vehicle and a distance up to another object or another vehicle.

A conventional LiDAR apparatus has detected a target by radiating a pulse and sensing reflected light that is reflected by the target. If a pulse is radiated, however, there is a difficulty in sensing a target at a long distance because it becomes difficult to sense reflected light that is reflected at the long distance. Furthermore, if the target is a human being, a LiDAR apparatus that radiates the pulse may pose a deadly threat to eye health if the pulse is incident on an eyeball. If a plurality of LiDAR apparatuses is present, there is a problem in that pieces of light that are radiated by the different apparatuses interfere with each other.

A LIDAR apparatus that has emerged due to such a problem is a frequency modulated continuous wave (FMCW) LiDAR apparatus. The FMCW LiDAR apparatus radiates, to a target, light having an oscillation frequency linearly changed over time, and senses a distance up to the target by sensing light that is reflected by the target and then incident thereon. The reflected light has a frequency having time delay depending on the distance. The FMCW LiDAR apparatus senses the location of a target by measuring a difference between the frequencies of transmitted light and received light.

In this case, the conventional LiDAR apparatus includes a construction for linearizing a modulation frequency because an accurate location of the target is sensed only when the modulation linearity of the frequency of the transmitted light is guaranteed.

The conventional LiDAR apparatus detects a current signal through an interferometer by distributing some of oscillating light because the light that is made oscillate by the LiDAR apparatus inevitably includes noise. The conventional LiDAR apparatus generates a reference signal not including noise, and extracts only a noise component by mixing the detected signal and the reference signal. The conventional LiDAR apparatus controls only the extracted noise component to be compensated for so that light having minimized noise can oscillate.

In this case, the conventional LiDAR apparatus uses a direct digital synthesizer (DDS) in generating the reference signal. However, the DDS consumes a considerably amount of power and generates considerable heat in its operation. Furthermore, the DDS has a problem in that it is difficult to reduce the size and weight of the DDS because the DDS additionally generates separate digital noise, requires a high cost, and has a volume having a predetermined level or more.

Accordingly, the conventional LiDAR apparatus has limits in its application or mounting.

### SUMMARY

An embodiment of the present disclosure is directed to providing an FMCW LiDAR apparatus in which multiple optical fibers are arranged in one direction so that light is radiated and a laser reflected by a target is condensed, which has high laser scan efficiency and can also be implemented at a low price.

An embodiment of the present disclosure is directed to providing an FMCW LiDAR apparatus having a size and manufacturing cost generally significantly reduced by reducing the size of the construction of a signal generator and reducing the manufacturing cost.

Furthermore, an embodiment of the present disclosure is directed to providing an FMCW LiDAR apparatus having significantly improved performance by minimizing an influence attributable to noise.

According to an aspect of the present embodiment, a Doppler LiDAR apparatus may include a plurality of light sources each configured to output light for detecting the speed of a target and a directivity of a moving target, an optical system configured to adjust the path or state of light to be output to the outside or reflected light that is reflected by the target, an interferometer configured to make the light that is output by any one of the plurality of light sources and the reflected light that has passed through the optical system interfere with each other, and a detection unit configured to detect information on the distance and speed of the target by receiving the light that has been subjected to interference in the interferometer.

According to an aspect of the present embodiment, the plurality of light sources includes a first light source configured to output the light for detecting the speed of the target and a second light source configured to output the light for detecting the directivity of the moving target.

According to an aspect of the present embodiment, the first light source detects the speed of the target by using a Doppler effect.

According to an aspect of the present embodiment, the first light source outputs light having a uniform frequency.

According to an aspect of the present embodiment, the second light source outputs light having a uniform frequency.

According to an aspect of the present embodiment, the optical system includes a transmission-optical system configured to adjust a path of the light that is output by the first light source so that the light proceeds to the target and a reception-optical system configured to adjust a path of the reflected light that is reflected by the target and that is incident from the outside so that the reflected light proceeds to the interferometer.

According to an aspect of the present embodiment, the interferometer makes the light that has been output by the second light source and the reflected light that has passed through the reception-optical system interfere with each other.

As described above, according to an aspect of the present embodiment, it is possible to very quickly obtain a three-dimensional image of a target because high-speed scan is possible.

According to an aspect of the present embodiment, there are advantages in that an overall size and manufacturing cost of the FMCW LiDAR apparatus can be reduced significantly by reducing the size and manufacturing cost of the construction of the signal generator.

Furthermore, according to an aspect of the present embodiment, it is possible to significantly improve performance by minimizing an influence attributable to noise.

### BRIEF DESCRIPTION OF THE DRAWINGS

FIG. 1 is a diagram illustrating a construction of an FMCW LiDAR apparatus according to an embodiment of the present disclosure.

FIG. 2 is a graph illustrating the characteristics of a change in the frequency of light for each time, which is output by the FMCW

LiDAR apparatus.

FIG. 3 is a diagram illustrating a construction of a light source unit according to an embodiment of the present disclosure.

FIG. 4 is a diagram illustrating a construction of an interferometer for measuring a phase error of light within the light source unit according to another embodiment of the present disclosure.

FIG. 5 is a graph illustrating the characteristics of a signal that needs to be generated by a signal generator within the FMCW LiDAR apparatus.

FIG. 6 is a diagram illustrating a construction of the signal generator within the FMCW LiDAR apparatus according to an embodiment of the present disclosure.

FIGS. 7 and 8A are diagrams illustrating a form in which the signal generator within the FMCW LiDAR apparatus according to an embodiment of the present disclosure operates.

FIGS. 8B and 8C illustrate frequency spectra of the FMCW LiDAR apparatus according to a distance to a target according to an embodiment of the present disclosure.

FIG. 9 is a diagram illustrating a construction of a light source unit according to another embodiment of the present disclosure.

FIG. 10 is a diagram illustrating a construction of a signal generator according to another embodiment of the present disclosure.

FIG. 11 is a diagram illustrating an implementation example of a waveform generation unit according to another embodiment of the present disclosure.

FIG. 12 is a graph illustrating an example of waveforms which may be generated by the waveform generation unit according to another embodiment of the present disclosure.

FIGS. 13A, 13B, 13C, 13D, 14A, 14B and 14C are diagrams exemplifying a process of the signal generator generating waveforms according to another embodiment of the present disclosure.

FIG. 15 is a circuit diagram illustrating a construction of a light source driving circuit within the FMCW LiDAR apparatus according to an embodiment of the present disclosure.

FIGS. 16A, 16B, and 16C are graphs illustrating the waveforms of respective power sources that are applied to the FMCW LiDAR apparatus according to an embodiment of the present disclosure.

FIG. 17 is a graph illustrating relations between currents, voltages, and pieces of power of a laser diode.

FIG. 18 is a diagram illustrating a construction of a light transmission unit according to an embodiment of the present disclosure.

FIG. 19 is a diagram illustrating an implementation example of the light transmission unit according to an embodiment of the present disclosure.

FIG. 20 is a diagram illustrating an implementation example of a transmission-optical system according to an embodiment of the present disclosure.

FIG. 21 is a diagram illustrating a construction of a light reception unit according to an embodiment of the present disclosure.

FIG. 22 is a diagram illustrating a construction of a signal processing unit according to an embodiment of the present disclosure.

FIGS. 23A and 23B are diagrams illustrating an implementation example of an interferometer within the signal processing unit according to an embodiment of the present disclosure.

FIG. 24 is a diagram illustrating a construction of a Doppler LiDAR apparatus according to another embodiment of the present disclosure.

FIG. 25 is a diagram illustrating a construction of a light source and a light path adjustment unit according to another embodiment of the present disclosure.

FIGS. 26A, 26B, 26C, and 26D are graphs illustrating the characteristics of a change in the frequency of light for each time, which is output by light sources, according to another embodiment of the present disclosure.

FIG. 27 is a diagram illustrating a construction of an error correction unit within a first light source according to another embodiment of the present disclosure.

FIG. 28 is a diagram illustrating a construction of an error correction unit within a second light source according to another embodiment of the present disclosure.

### DETAILED DESCRIPTION

The present disclosure may be changed in various ways and may have various embodiments. Specific embodiments are to be illustrated in the drawings and specifically described. It should be understood that the present disclosure is not intended to be limited to the specific embodiments, but includes all of changes, equivalents and/or substitutions included in the spirit and technical range of the present disclosure. Similar reference numerals are used for similar components while each drawing is described.

Terms, such as a first, a second, A, and B, may be used to describe various components, but the components should not be restricted by the terms. The terms are used to only distinguish one component from another component. For example, a first component may be referred to as a second component without departing from the scope of rights of the present disclosure. Likewise, a second component may be referred to as a first component. The term “and/or” includes a combination of a plurality of related and described items or any one of a plurality of related and described items.

When it is described that one component is “connected” or “coupled” to the other component, it should be understood that one component may be directly connected or coupled to the other component, but a third component may exist between the two components. In contrast, when it is described that one component is “directly connected to” or “directly coupled to” the other component, it should be understood that a third component does not exist between the two components.

Terms used in this application are used to only describe specific embodiments and are not intended to restrict the present disclosure. An expression of the singular number includes an expression of the plural number unless clearly defined otherwise in the context. In this specification, a term, such as “include” or “have”, is intended to designate the presence of a characteristic, a number, a step, an operation, a component, a part or a combination of them, and should be understood that it does not exclude the existence or possible addition of one or more other characteristics, numbers, steps, operations, components, parts, or combinations of them in advance.

All terms used herein, including technical terms or scientific terms, have the same meanings as those commonly understood by a person having ordinary knowledge in the art to which the present disclosure pertains, unless defined otherwise in the specification.

Terms, such as those defined in commonly used dictionaries, should be construed as having the same meanings as those in the context of a related technology, and are not construed as ideal or excessively formal meanings unless explicitly defined otherwise in the application.

Furthermore, each construction, process, procedure, or method included in each embodiment of the present disclosure may be shared within a range in which the constructions, processes, procedures, or methods do not contradict each other technically.

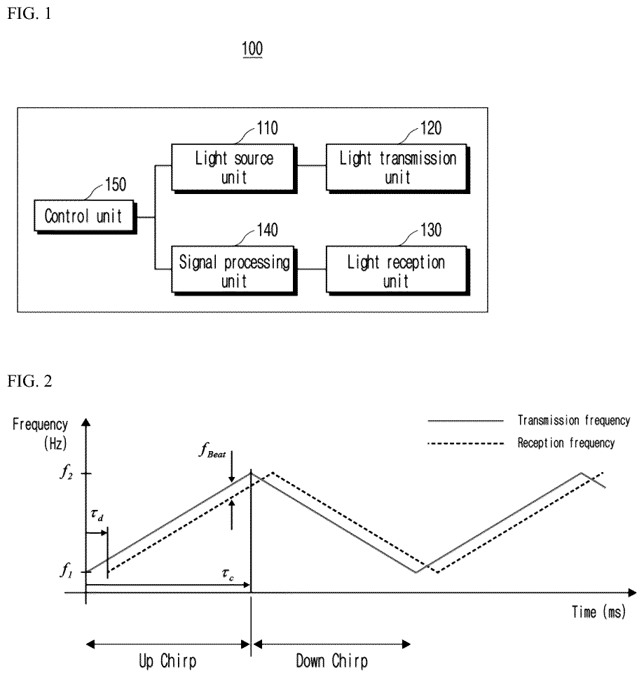

FIG. 1 is a diagram illustrating a construction of an FMCW LiDAR apparatus according to an embodiment of the present disclosure. FIG. 2 is a graph illustrating the characteristics of a change in the frequency of light for each time, which is output by the FMCW LiDAR apparatus.

Referring to FIG. 1, an FMCW LiDAR apparatus 100 according to an embodiment of the present disclosure includes a light source unit 110, a light transmission unit 120, a light reception unit 130, a signal processing unit 140, and a control unit 150.

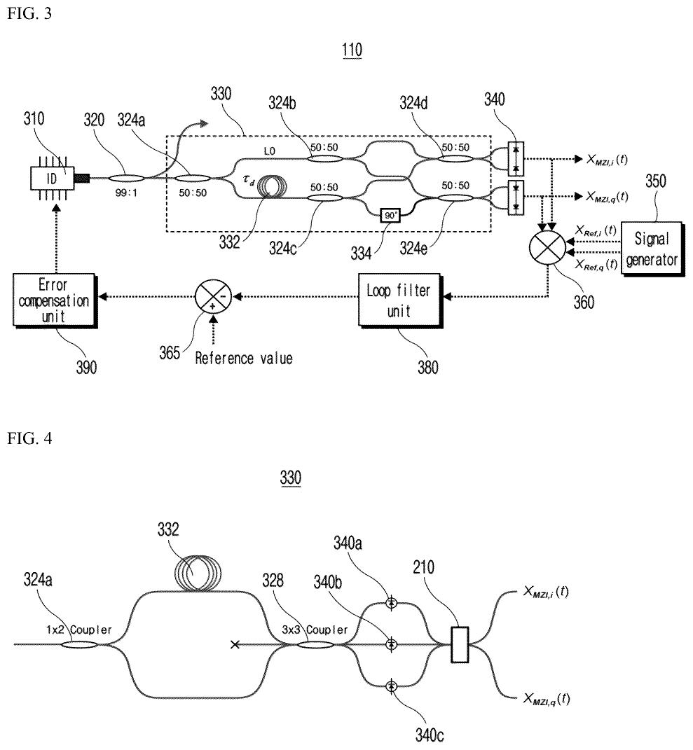

The light source unit 110 outputs light for detecting a target by receiving a current, but linearly changes a frequency characteristic of the light for each time, which is output by removing phase noise from the light. As will be described with reference to FIG. 3, the light source unit 110 does not include only a light source, but further includes a stabilization unit for removing phase noise included in light that is output by the light source and adjusting the frequency characteristic of the light. Accordingly, the light source unit 110 may output light having an ideal form as much as possible.

The light having an ideal form, which is made to oscillate by the light source unit 110, has characteristics illustrated in FIG. 2.

The light that is output by the light source unit 110 has the following characteristics of a transmission frequency for each time. The frequency of the light has a characteristic in which the frequency linearly changes between a first frequency (f1) and a second frequency (f2) over time. In this case, a change cycle (2τc), the first frequency, and the second frequency of the light are design values. Accordingly, a frequency change slope (κ) of the oscillating light is calculated as follows. The oscillating light may be defined as the following equation.

$$κ = \frac{{f}_{2} - {f}_{1}}{{τ}_{c}} , {f}_{TX} ( t ) = {f}_{1} + κ t$$

After the light having such a frequency characteristic for each time is output, reflected light that is reflected by the target has the same characteristic as the frequency characteristic of the output light for each time, but has a frequency characteristic in which the frequency has been delayed by a preset time (td) on a time axis. Accordingly, the reflected light may be defined as the following equation.

$${f}_{RX} ( t ) = {f}_{TX} ( t - {τ}_{d} ) = {f}_{1} + κ ( t - {τ}_{d} )$$

Accordingly, the light that is output by the light source unit 110 needs to have the frequency characteristic illustrated in FIG. 2. If the light has such a frequency characteristic, the light that oscillates regardless of time and the reflected light have a frequency difference (fbeat) corresponding to a preset numerical value.

$${f}_{TX} ( t ) - {f}_{RX} ( t ) = {f}_{Beat} = κ \times {τ}_{d}$$

$$R = \frac{c}{2 κ} \times {f}_{Beat}$$

In this case, R means a distance between the LiDAR apparatus and the target. c means the speed of the light. Since the frequency change slope and the speed of the light are known information, the LiDAR apparatus may detect a distance up to the target by detecting a difference between the frequencies of the output light and of the reflected light.

In order to satisfy the aforementioned equation, the frequency characteristic of the output light for each time, which has an ideal form, needs to linearly change. However, the light that is output by a light source within the light source unit 110 may inevitably include phase noise and a structural error.

In order to solve such a problem, the light source unit 110 includes the stabilization unit along with the light source so that the frequency characteristic of light for each time that is output by the light source linearly changes by removing phase noise and a structural error from the light. A detailed structure of the light source unit will be described later with reference to FIG. 3.

The light transmission unit 120 transmits light, which is output by the light source unit 110, to a detection area to be detected by the FMCW LiDAR apparatus 100. The light transmission unit 120 includes optical components for receiving light and dispersing or scanning the light to a detection area after adjusting the path of the light. The light transmission unit 120 receives light that is output by the light source unit 110, and transmits the light to a detection area by scanning or reflecting the light. The light transmission unit 120 may transmit the light by dispersing the light to the detection area in a lump, or may transmit the light in a form in which the light scans a corresponding area.

After the light transmission unit 120 transmits the light to the detection area, the light reception unit 130 receives reflected light that is reflected by the target. The light reception unit 130 includes optical components for receiving and focusing light or inputting reflected light to the signal processing unit 140 after adjusting the path of the light. The light reception unit 130 receives reflected light that is reflected by the detection area and transmits the reflected light to the signal processing unit 140.

The signal processing unit 140 receives the reflected light from the detection area, more specifically, the reflected light that is reflected by the target, and calculates a distance between the FMCW LiDAR apparatus 100 and the target. The distance between the FMCW LiDAR apparatus 100 and the target may be simply calculated by the aforementioned equation. Accordingly, the signal processing unit 140 calculates the distance between the FMCW LiDAR apparatus 100 and the target by detecting a difference between the frequencies of the output light and the reflected light.

The control unit 150 controls an operation of each of the components within the FMCW LiDAR apparatus 100.

FIG. 3 is a diagram illustrating a construction of the light source unit according to an embodiment of the present disclosure.

Referring to FIG. 3, the light source unit 110 according to an embodiment of the present disclosure includes a light source (LD) (or a light source driving circuit) 310 and a stabilization unit (not illustrated). The stabilization unit (not illustrated) includes distributors 320 and 324, an interferometer 330, a phase delayer 334, a light reception unit 340, a signal generator 350, a mixer 360, a loop filter unit 380, and an error compensation unit 390. Furthermore, the FMCW LiDAR apparatus 100 may further include a calculator 365.

The light source 310 outputs light for detecting a target by receiving a current. The light source 310 may be implemented as a single frequency laser diode (SFL) or a narrow spectral line width laser diode.

The light source 310 may output narrow band light having a long coherent length in order to maintain a coherent characteristic.

The coherent characteristic of the light means that the frequency and waveform of two pieces of light have the same state. The better the coherent characteristic, the more the interference phenomenon occurs. A coherent LiDAR apparatus can solve problems with the existing LiDAR apparatus, such as misdetection attributable to sunlight, a mutual interference problem between laser signals, or a risk to the eye. The coherent LiDAR apparatus needs to include a light source that makes narrow band light oscillate and a complex signal interferometer in order to have the aforementioned characteristic.

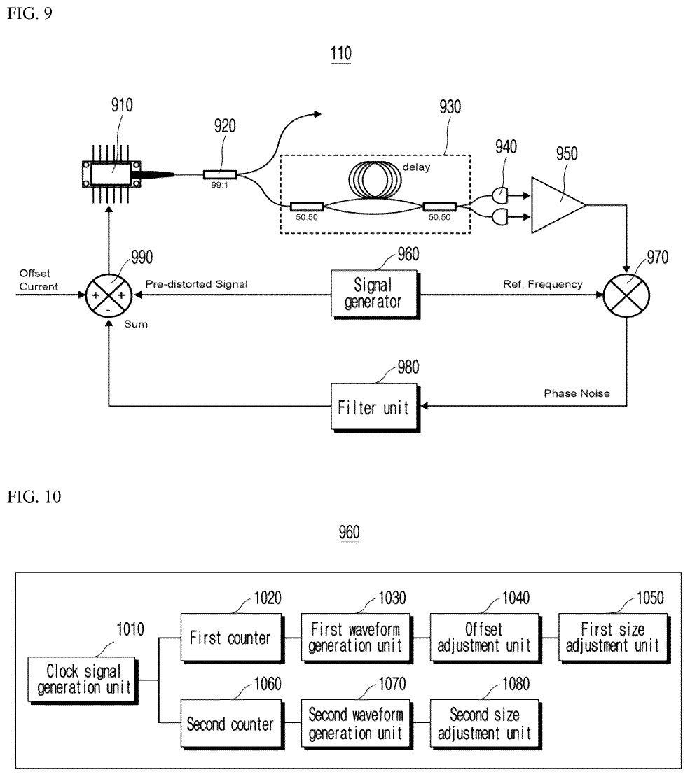

Detailed structures of the light source 310 and a driving circuit thereof will be described later with reference to FIGS. 9 to 11.

The light source 310 outputs light, but the light that is output by the light source 310 inevitably includes phase noise and a structural error. Accordingly, the stabilization unit (not illustrated) removes the phase noise and the structural error so that the frequency characteristic of the light for each time, which is output by the light source 310, linearly changes.

The distributor 320 distributes light that is output by the light source 310 into light for an operation (i.e., detecting a target) of the FMCW LiDAR apparatus 100 and light for frequency modulation linearization. The distributor 320 may distribute the light for the operation of the LiDAR apparatus at a preset ratio, for example, 90% or more compared to the light for the frequency modulation linearization. The light that has been distributed by the distributor 320 may be branched into a separate component (not illustrated) for detection within the LiDAR apparatus and radiated to the outside.

The light for the frequency modulation linearization, which has been branched from the distributor 320, is applied to the interferometer 330. The interferometer 330 performs time delay or phase delay on the applied light, and makes light that has not been delayed and light that has been subjected to time delay and/phase delay interfere with each other.

The distributor 324a distributes the light, which is applied to the interferometer 330, into two pieces of light at a ratio of 50:50. Any one of the two pieces of light distributed by the distributor 324a is applied to the distributor 324b without separate delay. In contrast, the other of the two pieces of light distributed by the distributor 324a is delayed through an optical fiber delay line 332 by a preset time (td) and then applied to the distributor 324c. The light that has been delayed by the preset time (td) through the optical fiber delay line 332 may be light corresponding to reflected light that is reflected by a target at a predetermined distance and that is delayed by a preset time in a processing process for frequency modulation linearization.

The light that has not been subjected to time delay and the light that has been subjected to time delay, through the distributor 324a, are incident on the distributors 324b and 324c, respectively, each of which branches light applied thereto into two pieces of light at a ratio of 50:50. Light that has not been subjected to time delay through each of the distributors 324b and 324c is branched into two pieces of light A and B. Light that has been subjected to time delay through each of the distributors 324b and 324c is branched into two pieces of light C and D. In this case, the phase of any one of the two pieces of light that have been branched and subjected to time delay through the distributor 324c is delayed by 90° through the phase delayer 334. That is, the light that is incident on the interferometer 330 is distributed as the two pieces of light A and B that have not been subjected to time delay, the one piece of light C that has been subjected to time delay, but has not been subjected to phase delay, and the one piece of light D that has been subjected to both time delay and phase delay. One of the two piece of light (i.e., any one of the two pieces of light A and B) that have not been subjected to time delay and the light C that has been subjected to time delay, but has not been subjected to phase delay are incident on the distributor 324d, and interfere with each other. The other of the two piece of light (i.e., the other of the two pieces of light A and B) that have not been subjected to time delay and the light D that has been subjected to both time delay and phase delay are incident on the distributor 324e, and interfere with each other.

The two pieces of light that are made to interfere with each other in the interferometer 330 appear as follows.

$${x}_{MZI , i} ( t ) = cos ( {κτ}_{d} t + {ϕ}_{N} ( t ) )$$

$${x}_{MZI , q} ( t ) = sin ( κ {τ}_{d} t + {ϕ}_{N} ( t ) )$$

In this case, xMZI,i(t) (hereinafter denoted as “first interference light”) means interference light of one piece of light that has not been subjected to time delay and light that has been subjected to time delay and that has not been subjected to phase delay. xMZI,q(t) (hereinafter denoted as “second interference light”) means interference light of one piece of light that has not been subjected to time delay and light that has been subjected to both time delay and phase delay. I means amplitude of the interference light. φN(t) means phase noise that has occurred.

The light reception unit 340 senses the first interference light and the second interference light as a first interference signal (i.e., a current signal) and a second interference signal (i.e., a current signal), respectively.

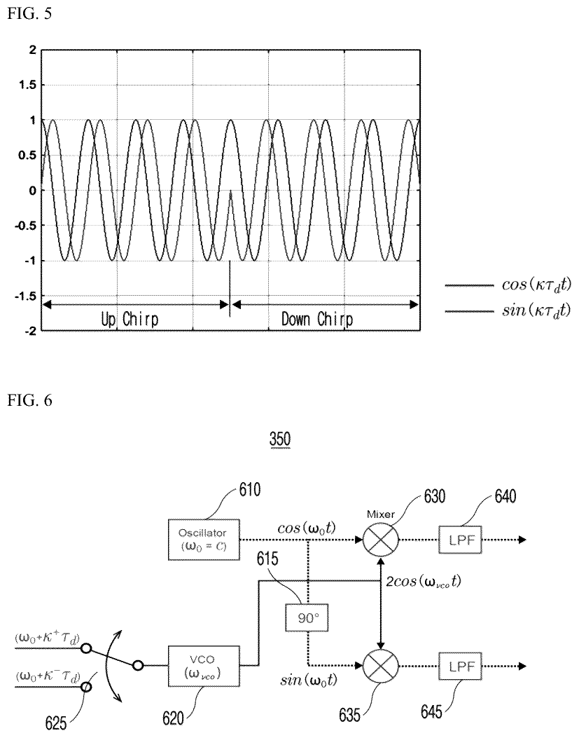

The signal generator 350 generates the first interference light (xRef,i(t)) and the second interference light (xRef,q(t)), which are ideal when phase noise does not occur, as current signals (hereinafter denoted as a “first reference signal” and a “second reference signal”). The first reference signal and the second reference signal that are generated by the signal generator 350 appear as follows, and have a characteristic illustrated in FIG. 5.

$${x}_{Ref , i} ( t ) = cos ( {κτ}_{d} t )$$

$${x}_{Ref , q} ( t ) = sin ( κ {τ}_{d} t )$$

FIG. 5 is a graph illustrating the characteristics of a signal that needs to be generated by the signal generator within the FMCW LiDAR apparatus.

Referring to FIG. 5, the first reference signal and the second reference signal each have an up-chirp interval and a down-chirp interval like the first interference signal and the second interference signal. In the up-chirp interval, the phase of any one of the first reference signal and the second reference signal is ahead of the phase of the other thereof. In the down-chirp interval, the phase of the other of the first reference signal and the second reference signal is ahead of the phase of one thereof. The signal generator 350 has the construction of FIG. 5 to be described later, and thus may generate the first reference signal and the second reference signal in an analog way and also fully implement even the up-chirp interval and the down-chirp interval.

Referring back to FIG. 3, the mixer 360 receives a first reference signal and a second reference signal from the light reception unit 340 and receives the first interference signal and the second interference signal from the signal generator 350, and mixes the received signals. The mixer 360 may perform a plurality of analog multiplications and one or more difference calculation operations. The mixer 360 mixes the aforementioned signals as follows.

$$\begin{matrix}{x}_{Mix ( t )} ≡ {x}_{MZI , q ( t )} ⊗ {x}_{Ref , i ( t )} ⊖ {x}_{MZI , j ( t )} ⊗ {x}_{Ref , q ( t )} \\ = sin ( κ {τ}_{d} t + {ϕ}_{N} ( t ) ) \times cos ( {κτ}_{d} t ) + cos ( {κτ}_{d} t + {ϕ}_{N} ( t ) ) \times sin ( κ {τ}_{d} t ) \\ = sin ( κ {τ}_{d} t + {ϕ}_{N} ( t ) - {κτ}_{d} t ) \\ = sin ( {ϕ}_{N} ( t ) )\end{matrix}$$

Alternatively, the mixer 360 mixes the aforementioned signals as follows.

$$\begin{matrix}{x}_{Mix ( t )} ≡ {x}_{MZI , i ( t )} ⊗ {x}_{Ref , i ( t )} ⊕ {x}_{MZI , q ( t )} ⊗ {x}_{Ref , q ( t )} \\ = cos ( {κτ}_{d} t + {ϕ}_{N} ( t ) ) \times cos ( {κτ}_{d} t ) + sin ( {κτ}_{d} t + {ϕ}_{N} ( t ) ) \times sin ( κ {τ}_{d} t ) \\ = cos ( {κτ}_{d} t + {ϕ}_{N} ( t ) - {κτ}_{d} t ) \\ = cos ( {ϕ}_{N} ( t ) )\end{matrix}$$

Through the mixing of the mixer 360, only a phase noise signal is output by the mixer 360.

The loop filter unit 380 receives the signal that has been mixed by the mixer 360, and filters out other noise from the signal. The loop filter unit 380 may be implemented as a loop filter, and may filter out other noise.

The error compensation unit 390 converts the phase noise signal that has passed through the loop filter unit 380 into a current signal, and applies, to the light source 310, a current having an error compensated for. Since a light signal that is output by the light source 310 is proportional to the current that is applied to the light source 310 for an operation, the error compensation unit 390 compensates for the phase noise signal with respect to the current that is applied to the light source 310. The error compensation unit 390 may be implemented as a current driver (not illustrated).

The error compensation unit 390 applies, to the light source 310, a current having a frequency noise value compensated for. Accordingly, the light (having the characteristics of a change in the frequency of light for each time) that has been described with reference to FIG. 2 may oscillate from the light source 310.

Furthermore, the FMCW LiDAR apparatus 100 may further include the calculator 365. A phase noise signal that is output by the mixer 360 has a sinusoidal form. However, in order for the error compensation unit 390 to perform error compensation more smoothly, it is preferred that the phase noise signal has a triangular wave form (similar to a form of the frequency of a signal that is output by the light source). Furthermore, in order for the error compensation unit 390 to perform error compensation more exactly, it is preferred that the waveform of the phase noise signal is disposed within an interval in which the waveform of the phase noise signal linearly changes, such as a −Π/2 to Π/2 interval when the phase noise signal has a sine waveform.

To this end, the FMCW LiDAR apparatus 100 includes the calculator 365. A signal that has passed through the loop filter unit 380 and a triangular waveform signal (i.e., a reference signal) are applied to the calculator 365. The calculator 365 receives and mixes the signal and the triangular waveform signal, and outputs a phase noise signal having a sinusoidal form, which has passed through the loop filter unit 380, as a triangular waveform signal. In this case, if the triangular waveform signal having a complete form is applied to the calculator 365 as a reference signal, the output phase noise signal has a triangular waveform, but may have a waveform having a partially distorted form. Accordingly, the triangular waveform signal that is applied to the calculator 365 as the reference signal may be a partially distorted waveform. As such a reference signal is applied to the calculator 365, a phase noise triangular waveform signal having a complete form may be output. The calculator 365 outputs the corresponding signal to the error compensation unit 390.

FIG. 4 is a diagram illustrating a construction of the interferometer for measuring a phase error of light within the light source unit according to another embodiment of the present disclosure.

The interferometer 330 according to an embodiment of the present disclosure may be implemented as illustrated in FIG. 4.

The distributor 324a branches light that is applied to the interferometer 330 into two pieces of light at a ratio of 50:50. Any one of the two pieces of light distributed by the distributor 324a is applied to the distributor 328 without separate delay. In contrast, the other of the two pieces of light distributed by the distributor 324a is delayed through the optical fiber delay line 332 by a preset time (τd) and then applied to the distributor 328.

The distributor 328 receives a light signal that has been subjected to time delay and a light signal that has not been subjected to time delay after the light has been distributed by the distributor 324a, and makes the received light signals interfere with each other as three signals.

First to third light reception units 340a, 340b, and 340c receive the three interference signals, respectively, which have been distributed after interfering with each other in the distributor 328. The interference signals that have interfered with each other in the light reception units 340a, 340b, and 340c, respectively, are as follows.

$${I}_{1} = I \cdot cos ( {κτ}_{d} t + {ϕ}_{N} ( t ) + \frac{2 π}{3} )$$

$${I}_{2} = I \cdot cos ( κ {τ}_{d} t + {ϕ}_{N} ( t ) )$$

$${I}_{3} = I \cdot cos ( κ {τ}_{d} t * {ϕ}_{N} ( t ) - \frac{2 π}{3} )$$

A complex signal generation unit 210 generates a first interference signal and a second interference signal by receiving the interference signals distributed by the distributor 328. The complex signal generation unit 210 generates the first interference signal and the second interference signal by subtracting or amplifying the two interference signals as follows.

$${x}_{MZI , i} ( t ) = {I}_{2} - \frac{1}{2} {I}_{1} - \frac{1}{2} {I}_{3}$$

$${x}_{MZI , q} ( t ) = \frac{\sqrt{3}}{2} ( {I}_{3} - {I}_{1} )$$

The interferometer 330 is implemented as illustrated in FIG. 4, and may make pieces of light applied thereto interfere with each other so that the first interference signal and the second interference signal are generated.

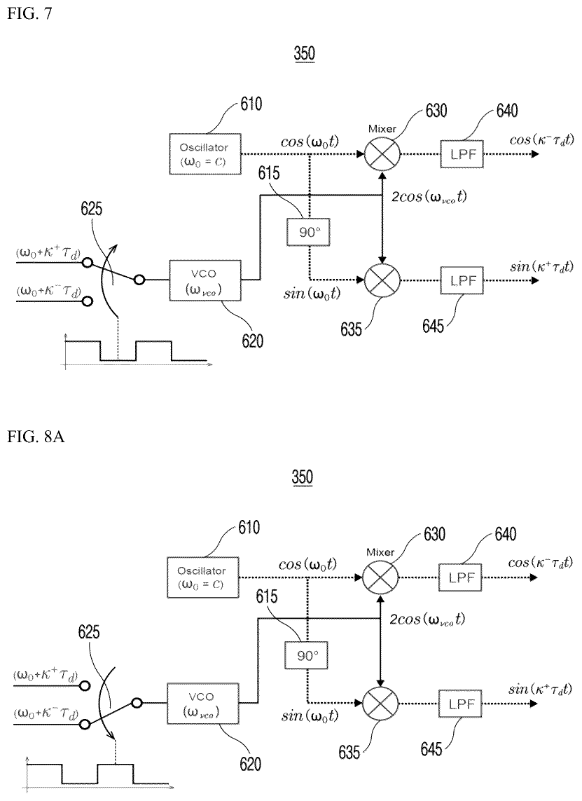

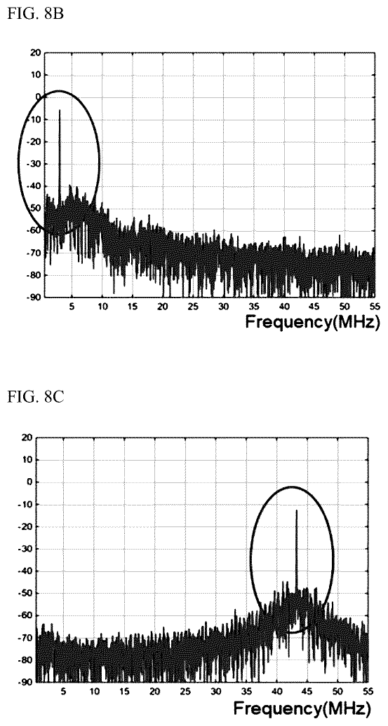

FIG. 6 is a diagram illustrating a construction of the signal generator within the FMCW LiDAR apparatus according to an embodiment of the present disclosure. FIGS. 7 and 8A are diagrams illustrating a form in which the signal generator within the FMCW LiDAR apparatus according to an embodiment of the present disclosure operates.

Referring to FIG. 6, the signal generator 350 according to an embodiment of the present disclosure includes an oscillator 610, a phase delayer 615, a voltage-controlled oscillator (VCO) 620, a switch 625, mixers 630 and 635 and the low pass filters (LPFs) 640 and 645.

The oscillator 610 generates a sine wave having a preset (or arbitrary) frequency (ω0). The oscillator 610 generates a sine wave having a preset frequency, for example, a cosine signal, and applies the cosine signal to the phase delayer 615 and the mixer 630.

The phase delayer 615 delays the phase of the cosine signal, which is applied by the oscillator 610, by 90°. Accordingly, when the cosine signal is generated by the oscillator 610, the cosine signal is output as a sine signal through the phase delayer 615. The phase delayer 615 applies, to the mixer 635, the sine signal by delaying the phase of the sine signal applied thereto.

The VCO 620 generates a sine wave that has a frequency corresponding to the size of a voltage based on the voltage applied thereto. As the switch 625 operates, the size of the voltage that is applied to the VCO 620 becomes different. As the switch 625 operates, the voltage that is applied to the VCO 620 has a size that makes the frequency of the sine wave generated by the VCO 620 have a first frequency or a second frequency. In this case, the first frequency may be a frequency, that is, the sum of a preset frequency (ω0) and a difference (κ+τd) between the frequencies of light that is output in the up-chirp interval and reflected light thereof. The second frequency may be a frequency, that is, the sum of the preset frequency (ω0) and a difference (κ−τd) between the frequencies of light that is output in the down-chirp interval and reflected light thereof. As the switch 625 operates, the VCO 620 generates a sine wave (i.e., a cosine signal) having the first frequency or a sine wave (i.e., a cosine signal) having the second frequency by receiving voltages having different sizes. The VCO 620 applies the sine wave to the mixers 630 and 635.

The switch 625 changes the size of the voltage that is applied to the VCO 620 so that the VCO 620 may generate the sine wave having the first frequency or the sine wave having the second frequency. The switch 625 selectively applies, to the VCO 620, any one of a voltage that enable the VCO 620 to output the sine wave having the first frequency and a voltage that enable the VCO 620 to output the sine wave having the second frequency. Accordingly, although the signal generator 350 is implemented by only analog components, the signal generator 350 may generate the first and second reference signals that are intact, and may divisively generate even reference signals in the up-chirp interval and the down-chirp interval.

The mixer 630 mixes the sine wave generated by the oscillator 610 and the sine wave generated by the VCO 620.

As illustrated in FIG. 7, when the mixer 630 receives the sine wave having the first frequency, which has been generated by the VCO 620, along with the sine wave generated by the oscillator 610, the mixer 630 mixes the signals as follows.

$$= 2 cos ( {ω}_{v c o} t ) cos ( {ω}_{0} t )$$

$$= 2 cos ( {ω}_{0} t + {κ}^{+} {τ}_{d} t ) cos ( {ω}_{0} t )$$

$$= cos ( {ω}_{0} t + {κ}^{+} {τ}_{d} t + {ω}_{0} t ) + cos ( {ω}_{0} t + {κ}^{+} {τ}_{d} t - {ω}_{0} t )$$

$$= cos ( 2 {ω}_{0} t + {κ}^{+} {τ}_{d} t ) + cos ( {κ}^{+} {τ}_{d} t )$$

As illustrated in FIG. 8, when the mixer 630 receives the sine wave having the second frequency, which has been generated by the VCO 620, along with the sine wave generated by the oscillator 610, the mixer 630 mixes the signals as follows.

$$= 2 cos ( {ω}_{v c o} t ) cos ( {ω}_{0} t )$$

$$= 2 cos ( {ω}_{0} t + {κ}^{-} {τ}_{d} t ) cos ( {ω}_{0} t )$$

$$= cos ( {ω}_{0} t + {κ}^{-} {τ}_{d} t + {ω}_{0} t ) + cos ( {ω}_{0} t + {κ}^{-} {τ}_{d} t - {ω}_{0} t )$$

$$= cos ( 2 {ω}_{0} t + {κ}^{-} {τ}_{d} t ) + cos ( {κ}^{-} {τ}_{d} t )$$

The mixer 635 mixes the sine wave that has passed through the phase delayer 615 and the sine wave that has been generated by the VCO 620.

As illustrated in FIG. 7, when the mixer 635 receives the sine wave having the first frequency, which has been generated by the VCO 620, along with the sine wave that has passed through the phase delayer 615, the mixer 630 mixes the signals as follows.

$$= 2 cos ( {ω}_{v c o} t ) sin ( {ω}_{0} t )$$

$$= 2 cos ( {ω}_{0} t + {κ}^{+} {τ}_{d} t ) sin ( {ω}_{0} t )$$

$$= cos ( {ω}_{0} t + {κ}^{+} {τ}_{d} t + {ω}_{0} t ) - sin ( {ω}_{0} t + {κ}^{+} {τ}_{d} t - {ω}_{0} t )$$

$$= cos ( 2 {ω}_{0} t + {κ}^{+} {τ}_{d} t ) - sin ( {κ}^{+} {τ}_{d} t )$$

As illustrated in FIG. 8, when the mixer 630 receives the sine wave having the second frequency, which has been generated by the VCO 620, along with the sine wave generated by the oscillator 610, the mixer 630 mixes the signals as follows.

$$= 2 cos ( {ω}_{v c o} t ) sin ( {ω}_{0} t )$$

$$= 2 cos ( {ω}_{0} t + {κ}^{-} {τ}_{d} t ) sin ( {ω}_{0} t )$$

$$= cos ( {ω}_{0} t + {κ}^{-} {τ}_{d} t + {ω}_{0} t ) - sin ( {ω}_{0} t + {κ}^{-} {τ}_{d} t - {ω}_{0} t )$$

$$= cos ( 2 {ω}_{0} t + {κ}^{-} {τ}_{d} t ) - sin ( {κ}^{-} {τ}_{d} t )$$

The mixers 630 and 635 mix the signals, respectively, as described above, and apply the mixed signals to the LPFs 640 and 645, respectively.

Each of the LPFs 640 and 645 filters out components other than the first and second reference signals from the signal applied thereto.

As illustrated in FIG. 7, when the signals are applied to the LPFs 640 and 645, respectively, each LPF performs the filtering as follows.

$$\begin{matrix}LPF ( 64 \; 0 ) = cos ( 2 {ω}_{0} t + {κ}^{+} {τ}_{d} t ) + cos ( {κ}^{+} {τ}_{d} t ) \\ = cos ( {κ}^{+} {τ}_{d} t ) \\ = cos ( - {κ}^{+} {τ}_{d} t ) \\ = cos ( {κ}^{-} {τ}_{d} t ) ( ∵ {κ}^{+} = - {κ}^{-} )\end{matrix}$$

$$\begin{matrix}LPF ( 64 \; 5 ) = cos ( 2 {ω}_{0} t + {κ}^{+} {τ}_{d} t ) - sin ( {κ}^{+} {τ}_{d} t ) \\ = - sin ( {κ}^{+} {τ}_{d} t ) \\ = sin ( - {κ}^{+} {τ}_{d} t ) \\ = sin ( {κ}^{-} {τ}_{d} t )\end{matrix}$$

Accordingly, in the up-chirp interval, the signal generator 350 may output the aforementioned signal.

In contrast, as illustrated in FIG. 8, when the signals are applied to the LPFs 640 and 645, respectively, each LPF performs the filtering as follows.

$$\begin{matrix}LPF ( 64 \; 0 ) = cos ( 2 {ω}_{0} t + {κ}^{-} {τ}_{d} t ) + cos ( {κ}^{-} {τ}_{d} t ) \\ = cos ( {κ}^{+} {τ}_{d} t ) \\ = cos ( - {κ}^{+} {τ}_{d} t ) \\ = cos ( {κ}^{+} {τ}_{d} t )\end{matrix}$$

$$\begin{matrix}LPF ( 64 \; 5 ) = cos ( 2 {ω}_{0} t + {κ}^{-} {τ}_{d} t ) - sin ( {κ}^{-} {τ}_{d} t ) \\ = - sin ( {κ}^{-} {τ}_{d} t ) \\ = sin ( - {κ}^{-} {τ}_{d} t ) \\ = sin ( {κ}^{+} {τ}_{d} t )\end{matrix}$$

Accordingly, in the down-chirp interval, the signal generator 350 may output the aforementioned signal.

That is, although the signal generator 350 includes only analog components, the signal generator 350 may generate the first and second reference signals that are intact. In particular, in generating the first and second reference signals, the signal generator 350 may wholly generate the first and second reference signals that are suitable for each of the up-chirp interval and the down-chirp interval, by dividing the up-chirp interval and the down-chirp interval.

FIGS. 8B and 8C illustrate frequency spectra of the FMCW LiDAR apparatus according to a distance to a target according to an embodiment of the present disclosure.

The FMCW LiDAR apparatus 100 can obtain a relatively high signal to noise ratio although a target is disposed at a long distance as illustrated in FIG. 8C in addition to a case in which a target is disposed at a short distance as illustrated in FIG. 8B. Accordingly, the FMCW LiDAR apparatus 100 can obtain a sharp bit frequency when performing frequency signal processing by FFT.

FIG. 9 is a diagram illustrating a construction of the light source unit according to another embodiment of the present disclosure.

Referring to FIG. 9, the light source unit 110 according to another embodiment of the present disclosure includes a light source 910 and a stabilization unit (not illustrated). The stabilization unit (not illustrated) includes a distributor 920, an interferometer 930, a light reception unit 940, an amplifier 950, a signal generator 960, a mixer 970, a filter unit 980, and a calculation unit 990.

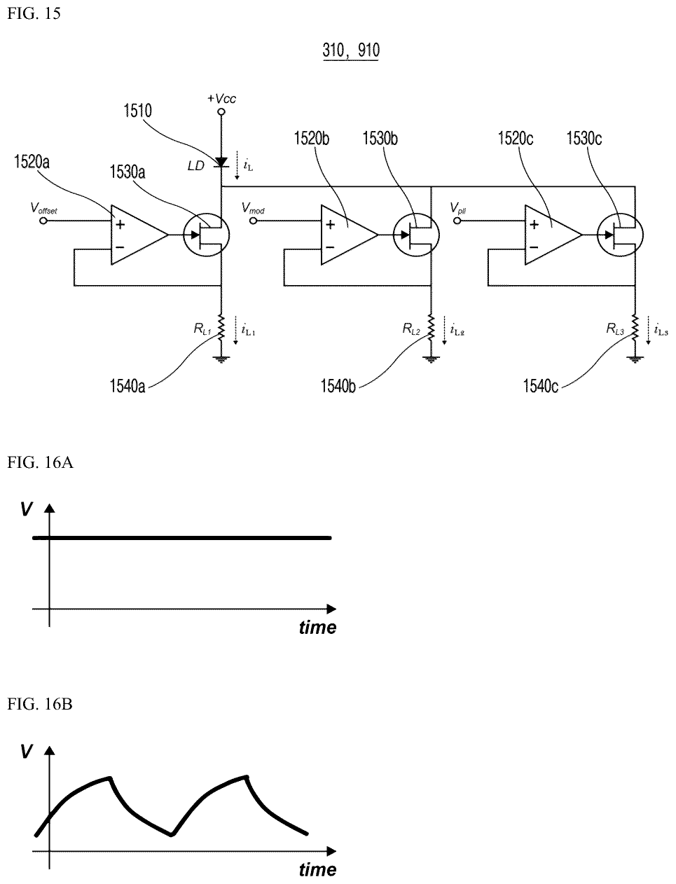

The light source 910 makes light for detecting a target oscillate by receiving a current. The light source 910 may be implemented as a narrow line width laser diode. A detailed structure of the light source 910 and a driving circuit thereof will be described later with reference to FIG. 15.

The distributor 920 distributes the light that is output by the light source 910 into light for an operation (i.e., detecting a target) of the LiDAR apparatus 100 and light for frequency modulation linearization. The distributor 920 may distribute the light for an operation of the LiDAR apparatus at a preset ratio, for example, 90% or more compared to the light for frequency modulation linearization. The light distributed by the distributor 920 may be branched into a separate component (not illustrated) for detection within the LiDAR apparatus and radiated to the outside.

The light that has been branched for frequency modulation linearization by the distributor 920 is applied to the interferometer 930. The interferometer 930 makes some of the applied light subjected to time delay, and makes light that has not been delayed and light that has been subjected to time delay interfere with each other. Furthermore, the interferometer may make some of the applied light subjected to both time delay and/or phase delay, and may make light that has not been delayed and light that has been subjected to time delay and/phase delay interfere with each other.

The interferometer 930 includes a first distributor, a delay line, and a second distributor, forms light that has not been delayed and light that has been subjected to time delay, and makes the light that has not been delayed and the light that has been subjected to time delay interfere with each other. Accordingly, the following interference light is formed.

$${x}_{MZI} ( t ) = sin ( κ {τ}_{d} t + {ϕ}_{n} ( t ) )$$

In this case, xMZI(t) (hereinafter denoted as “interference light”) means interference light of the light that has not been subjected to time delay and the light that has been subjected to time delay. φN(t) means phase noise that has occurred.

Furthermore, the interferometer 930 may increase the number of pieces of interference light that is generated by including more distributors. Furthermore, the interferometer 930 may further include a phase delayer, may form light that has not been subjected to both time delay and phase delay, light that has been subjected to time delay, but that has been not subjected to phase delay, and light that has been subjected to both time delay and phase delay, and may make the light that has not been subjected to both time delay and phase delay, the light that has been subjected to time delay, but that has been not subjected to phase delay, and the light that has been subjected to both time delay and phase delay interfere with one another. Accordingly, the interferometer 930 may form a plurality of pieces of interference light.

The light reception unit 940 senses the interference light as an interference signal (or a current signal).

The amplifier 950 amplifies the interference signal of the light reception unit 940 and converts the interference signal into a voltage signal. The amplifier 950 may be implemented as a trans-impedance amplifier (TIA), and may perform the aforementioned operation.

The signal generator 960 generates ideal interference light (X_{Ref}(t)) when phase noise has not occurred as a voltage signal (hereinafter denoted as a “reference signal”), and applies the reference signal to the mixer 970. The reference signal that is generated by the signal generator 960 is represented as follows.

$${x}_{Ref} ( t ) = cos ( κ {τ}_{d} t )$$

The reference signal that is generated by the signal generator 960 has a form in which a sine wave and a harmonics signal thereof have been combined. However, the reference signal that is generated by the signal generator 960 has a form that includes only a pure sine wave and a harmonics signal thereof, and has a form that does not include other noise.

Furthermore, the signal generator 960 generates a partially distorted triangular waveform and applies the partially distorted triangular waveform to the calculation unit 990 so that the calculation unit 990 can apply a current having phase noise compensated for to the light source 910. In this case, the signal generator 960 has a construction to be described with reference to FIGS. 10 to 14, and thus may perform all of the aforementioned operations although the signal generator is implemented by only relatively and significantly small and cheap analog components.

The mixer 970 receives an interference signal from the amplifier 950, receives the reference signal from the signal generator 960, and mixes the interference signal and the reference signal. The mixer 970 may perform a plurality of analog multiplication operations, or may perform one or more difference calculation operations along with a multiplication operation. The mixer 970 mixes the interference signal and the reference signal as follows.

$$\begin{matrix}{x}_{M i x ( t )} ≡ {x}_{MZI} ( t ) ⊗ {x}_{Ref} ( t ) \\ = sin ( κ {τ}_{d} t + {ϕ}_{N} ( t ) ) \times ( {κτ}_{d} t ) \\ = \frac{1}{2} sin ( {ϕ}_{N} ( t ) ) + \frac{1}{2} sin ( 2 κ {τ}_{d} t + {ϕ}_{n} ( t ) )\end{matrix}$$

According to the mixing of the mixer 970, a signal including only a phase noise component and a harmonics signal are output.

The filter unit 980 receives the signal that has been mixed by the mixer 970, and filters out the remaining components except the signal including only the phase noise component. The filter unit 980 may be implemented as any filter capable of filtering out the remaining components except the signal including only the phase noise component, may be implemented as a band pass filter (BPF) or a band reject filter (BRF), for example, and may be implemented as a notch filter in order to derive a more excellent effect.

Furthermore, the filter unit 980 may further include a loop filter in addition to the aforementioned filter. The loop filter may remove other noise within a signal, and may improve the linearity of a signal to be output by the light source 910.

The calculation unit 990 receives the phase noise signal that has passed through the filter unit 980, the partially distorted triangular waveform from the signal generator 960, and an offset signal from the outside, and applies a current having an error compensated for (i.e., a current that enables the light source to output an ideal output signal) to the light source 910. The light signal that is output by the light source 910 is proportional to the current that is applied to the light source 910 for an operation. Accordingly, the calculation unit 990 compensates for the phase noise signal with respect to the current that is applied to the light source 910.

In this case, the phase noise signal that is output by the mixer 970 has a sinusoidal form. However, in order for error compensation to be more smoothly performed in the calculation unit 990, it is preferred that the phase noise signal has a triangular wave form (similar to a form of the frequency of the signal that is output by the light source).

To this end, the partially distorted triangular waveform from the signal generator 960, in addition to the phase noise signal that has passed through the filter unit 980, is applied to the calculation unit 990. The calculation unit 990 receives and mixes both the signals, and outputs the phase noise signal (having a sinusoidal form) that has passed through the filter unit 980 as a triangular waveform signal. At this time, when the triangular waveform signal having a complete form is applied from the signal generator 960 to the calculation unit 990, the phase noise signal that is output has a triangular waveform, but may have a waveform having a form partially distorted. Accordingly, as the partially distorted triangular waveform is applied from the signal generator 960 to the calculation unit 990, a phase noise triangular waveform signal having a complete form may be formed, and the phase noise signal can be accurately compensated for.

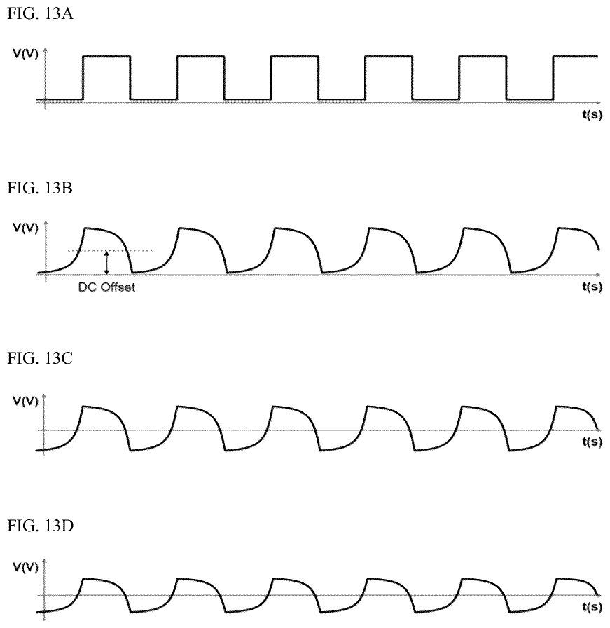

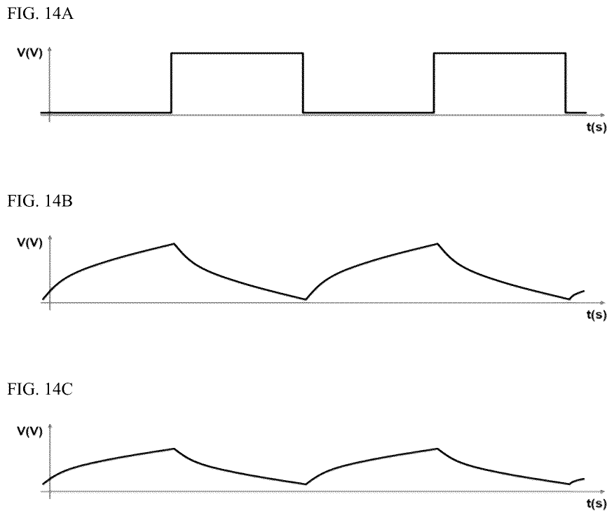

FIG. 10 is a diagram illustrating a construction of the signal generator according to another embodiment of the present disclosure. FIGS. 13 and 14 are diagrams exemplifying a process of the signal generator generating waveforms according to another embodiment of the present disclosure.

Referring to FIG. 10, the signal generator 960 according to an embodiment of the present disclosure includes a clock signal generation unit 1010, a first counter 1020, a first waveform generation unit 1030, an offset adjustment unit 1040 a first size adjustment unit 1050, a second counter 1060, a second waveform generation unit 1070, and a second size adjustment unit 1080. In this case, the first counter 1020, the first waveform generation unit 1030, the offset adjustment unit 1040, and the first size adjustment unit 1050 generate a reference signal and apply the reference signal to the mixer 970. The second counter 1060, the second waveform generation unit 1070, and the second size adjustment unit 1080 generate a partially distorted triangular waveform signal and apply the partially distorted triangular waveform signal to the calculation unit 990.

The clock signal generation unit 1010 generates a clock signal having a square waveform. The clock signal generation unit 1010 generates the clock signal having a square waveform having 0 or 1, as illustrated in FIG. 13(a) or 14(a). The clock signal generation unit 1010 may be a component that is embedded in a CPU, and may be a component that separately generates only a clock signal. The clock signal generation unit 1010 may be implemented very cheaply although the clock signal generation unit is implemented by using any component.

The first counter 1020 counts the clock signal by receiving the clock signal that is generated by the clock signal generation unit 1010. The first counter 1020 counts the clock signal so that the reference signal to be generated has a proper frequency. For example, assuming that the reference signal has a frequency of 1.5 MHz and the clock signal has a frequency of 48 MHZ, the first counter 1020 may count the clock signal by branching the clock signal into 32 so that the reference signal has the corresponding frequency. Accordingly, the first counter 1020 counts the clock signal so that a clock signal having a frequency, such as that illustrated in FIG. 13(a), is generated.

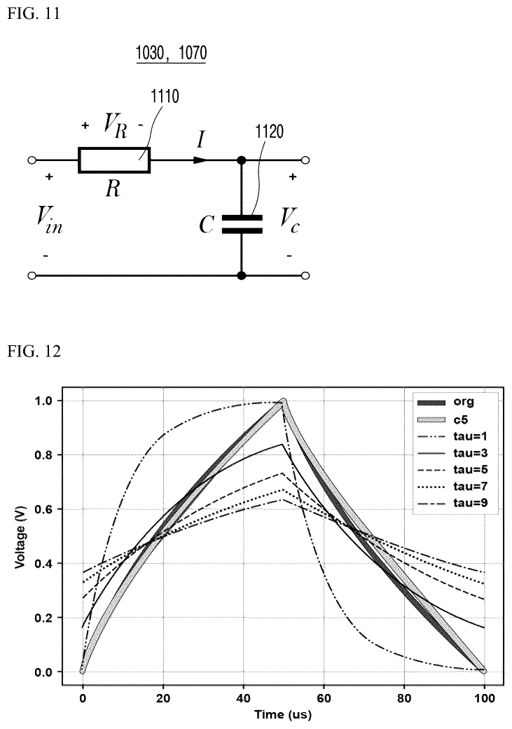

The first waveform generation unit 1030 generates the reference signal having a preset waveform by receiving the clock signal that is counted (or generated) by the first counter 1020. In this case, the preset waveform has a form that includes a sine wave and harmonics thereof. The first waveform generation unit 1030 may be implemented as an RC circuit which may be implemented very small and cheaply as illustrated in FIG. 11, for example, a low pass filter (LPF).

FIG. 11 is a diagram illustrating an implementation example of a waveform generation unit according to another embodiment of the present disclosure. FIG. 12 is a graph illustrating an example of waveforms which may be generated by the waveform generation unit according to another embodiment of the present disclosure.

Referring to FIG. 11, the waveform generation unit 1030, 1070 according to an embodiment of the present disclosure has been implemented in the form of an RC circuit in which a resistor 1110 and a capacitor 1120 have been connected in series. A voltage (Vin) is applied to the entire waveform generation unit 1030, 1070. A voltage (Vc) that is applied to both ends of the capacitor 1120 is output.

In this case, a form of the voltage (Vc) that is output varies depending on the size of a time constant (τ=R*C) that is formed by the resistor 1110 and the capacitor 1120 as illustrated in FIG. 11.

As illustrated in FIG. 12, assuming that an ideal signal to be output is an org signal or a c5 signal, when the time constant has a range of 3 to 9, the waveform generation unit 1030, 1070 may output a signal that has a size different from the size of the ideal signal, but has a waveform very similar to the waveform of the ideal signal. Furthermore, when the time constant is 1, the waveform generation unit 1030, 1070 may output a signal having a sinusoidal form. The corresponding sine wave signal is not a pure sine wave or cosine wave not having a harmonics component, but has a form in which only a harmonics component having the corresponding waveform has been combined with the pure sine wave or cosine wave. That is, the signal having a sinusoidal form, which is generated by the waveform generation unit 1030, 1070, has a form that includes only a sine wave component and a harmonics component thereof.

Referring back to FIG. 10, if the first waveform generation unit 1030 is implemented as described above, the first waveform generation unit 1030 generates a reference signal having a preset waveform (i.e., a waveform including a sine wave and a harmonics component thereof), such as that illustrated in FIG. 13(b).

The offset adjustment unit 1040 adjusts an offset value of the reference signal that has been generated by the first waveform generation unit 1030. The offset adjustment unit 1040 may be implemented as a high pass filter (HPF), and adjusts the offset value of the reference signal that has been generated by the first waveform generation unit 1030. The reference signal that has been generated by the first waveform generation unit 1030 has been generated based on the clock signal generated by the first counter 1020. Accordingly, the reference signal has a value within a range of 0 to 1 like the clock signal. However, the reference signal needs to have a form in which amplitude thereof varies on the basis of 0 because the reference signal has to have a form that includes a sine wave or a sine wave and harmonics thereof. Accordingly, the offset adjustment unit 1040 adjusts the offset value of the reference signal that has been generated by the first waveform generation unit 1030 so that the reference signal has a form in which a value of the reference signal varies on the basis of 0 as illustrated in FIG. 13(c).

The first size adjustment unit 1050 adjusts the amplitude of the reference signal that has passed through the offset adjustment unit 1040. The first size adjustment unit 1050 is implemented as a component that adjusts the amplitude of a signal, such as an attenuator, and adjusts the amplitude of the reference signal. As described above, the waveform generation unit may generate a waveform that is the same as or similar to the waveform of a signal to be generated, but has a difficulty in making even the amplitude of a signal identical with or similar to the amplitude of a signal that needs to be generated. Accordingly, as illustrated in FIG. 13(d), the first size adjustment unit 1050 generates the reference signal that has passed through the offset adjustment unit 1040 as a reference signal having a form to be output by finally adjusting the amplitude of the reference signal that has passed through the offset adjustment unit 1040. The first size adjustment unit 1050 applies the generated reference signal to the mixer 970.

The second counter 1060, the second waveform generation unit 1070, and the second size adjustment unit 1080 perform the same operation as the first counter 1020, the first waveform generation unit 1030, and the first size adjustment unit 1050. However, as described above, as the second counter 1060, the second waveform generation unit 1070, and the second size adjustment unit 1080 generate the partially distorted triangular waveform signal, a branch that is counted by the second counter 1060 (i.e., the frequency of the clock signal that is finally generated) and the waveform that is generated by the second waveform generation unit 1070 have different forms.

The second counter 1060 counts a clock signal by receiving the clock signal that is generated by the clock signal generation unit 1010. The second counter 1060 counts the clock signal so that a triangular waveform signal to be generated has a proper frequency. For example, assuming that the triangular waveform signal has a frequency of 10 kHz and the clock signal has a frequency of 48 MHZ, the second counter 1060 may count the clock signal by branching the clock signal into 10800 so that the triangular waveform signal has the corresponding frequency. Accordingly, the second counter 1060 counts the clock signal so that a clock signal having a frequency, such as that illustrated in FIG. 14 (a), is generated.

The second waveform generation unit 1070 generates a partially distorted triangular waveform signal by receiving the clock signal that has been counted by the second counter 1060 as illustrated in FIG. 14 (b). The second waveform generation unit 1070 is implemented as an RC circuit, and may generate the partially distorted triangular waveform signal based on a value of the time constant.

The second size adjustment unit 1080 adjusts the size of the waveform that has been generated by the second waveform generation unit 1070. The second size adjustment unit 1080 generates the triangular waveform signal that has passed through the second waveform generation unit 1070 as a triangular waveform signal having a size to be output as illustrated in FIG. 14 (c). The second size adjustment unit 1080 applies the generated (partially distorted) triangular waveform signal to the calculation unit 990.

The signal generator 960 is implemented as described above, and thus the size and manufacturing cost of the signal generator can be significantly reduced compared to a conventional direct digital synthesizer (DDS). Furthermore, the signal generator 960 has been implemented as an analog digital mix circuit, but can be effectively constructed and operate at a low cost because the signal generator does not include an expensive high-speed and high-resolution digital to analog converter (DAC) or an expensive analog mixer.

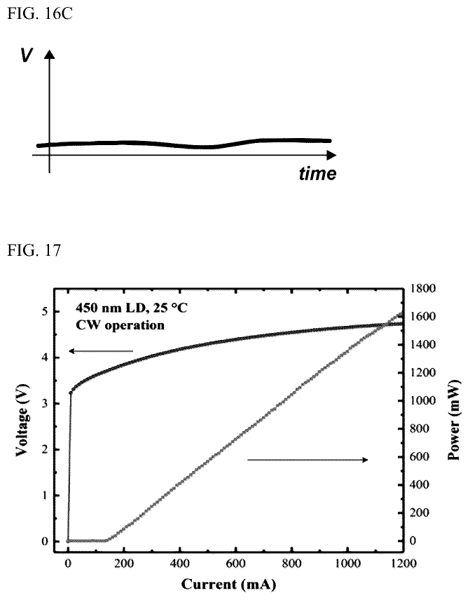

FIG. 15 is a circuit diagram illustrating a construction of the light source driving circuit within the FMCW LiDAR apparatus according to an embodiment of the present disclosure. FIG. 16 is a graph illustrating the waveforms of respective power sources that are applied to the FMCW LiDAR apparatus according to an embodiment of the present disclosure. FIG. 17 is a graph illustrating relations between currents, voltages, and pieces of power of a laser diode.

Referring to FIG. 15, the light source driving circuit 310, 1510 of the FMCW LiDAR apparatus according to an embodiment of the present disclosure includes a laser diode 1510, a plurality of amplifiers 1520 (1520a to 1520n), a plurality of switches 1530 (1530a to 1530n), and a plurality of load resistors 1540 (1540a to 1540n).

The laser diode 1510 is a device for making light oscillate. When a current having a threshold value or more flows as illustrated in FIG. 17, the laser diode 1510 has a characteristic in which the intensity (or power) of oscillating light is proportional to a driving current.

As illustrated in FIG. 16, a voltage that is input to the light source driving circuit 310 within the FMCW LiDAR apparatus includes an offset voltage (V_{offset}, FIG. 16a), a voltage (V_{mod}, FIG. 16b) for frequency modulation, and a PLL compensation voltage (Vₚₗₗ, FIG. 16c) for compensating for phase noise. In this case, the size of the offset voltage (V_{offset}) is relatively very great compared to the voltage (V_{mod}) and the PLL compensation voltage (Vₚₗₗ). Accordingly, there is a problem because the light source and the driving driver within the conventional FMCW LiDAR apparatus process power having different sizes by using the same load resistor. Accordingly, the light source driving circuit 310 includes the plurality of amplifiers 1520a to 1520n, the plurality of switches 1530a to 1530n, and the plurality of load resistors 1540a to 1540n.

The laser diode 1510 makes light oscillate with the intensity proportional to a current (ir) that flows into the light source driving circuit 310.

The amplifiers 1520 receive different voltages that are input to the light source driving circuit 310, transmit the voltages to the load resistors 1540, respectively, and simultaneously output output signals to gate stages the of switches 1530, respectively. Accordingly, the amplifier 1520 transmits the input voltage to the load resistor 1540. When the voltage is input to the amplifier 1520, the switch 1530 is connected so that the current (i_{L}) flowing into the driving circuit is transmitted to the laser diode 1510.

The switch 1530 controls whether a current will flow into the light source driving circuit 310. The switch 1530 receives the voltage from the amplifier 1520 through its gate stage depending on whether the voltage is applied to the light source driving circuit 310, so that the on/off of the switch is controlled.

Each voltage that is input to the light source driving circuit 310 as described above has a characteristic in which the voltage has a different size and waveform. Accordingly, the light source driving circuit 310 includes the amplifier 1520, the switch 1530, and the load resistor 1540 each number of which is equal to or greater than the number of voltages that are input to the light source driving circuit 310.

In this case, the load resistors 1540a to 1540n are implemented to have different sizes depending on the sizes of (different) voltages applied thereto so that noise and the generation of heat in the load resistor can be reduced as much as possible and an output having a predetermined level or more can also be secured through a current that is not too small. Through such a structure, a different voltage that is input to the light source driving circuit 310 is applied to one input stage of each of the amplifiers 1520a to 1520n. The switches 1530a to 1530n are connected to output stages of the amplifiers 1520a to 1520n, respectively. Each of the different load resistors 1540a to 1540n (regardless of the sizes thereof) is connected to the other input stage of each of the amplifiers 1520a to 1520n. Accordingly, a current corresponding to an applied voltage is generated.

As exemplified in FIG. 15, a current (i_{L1}) that flows along the amplifier 1520a, the switch 1530a, and the load resistor 1540a to which the offset voltage (V_{offset}) is applied is calculated as follows.

$${i}_{L {1}^{=}} \frac{{V}_{offset}}{{R}_{L 1}}$$

In this case, R_{L1} indicates the size of the load resistor 1540a. Likewise, a current (i_{L2}) that flows into the load resistor 1540b to which the voltage (V_{mod}) for frequency modulation is applied and a current (i_{L3}) that flows into the load resistor 1540c to which the PLL compensation voltage (Vₚₗₗ) is applied are calculated as follows.

$${i}_{L 2} = \frac{{V}_{m o d}}{{R}_{L 2}}$$

$${i}_{L 3} = \frac{{V}_{p 11}}{{R}_{L 3}}$$

In this case, R_{L2} and R_{L3} indicate the sizes of the load resistor 1540b and the load resistor 1540c, respectively.

The current (i_{L}) that flows into the laser diode 1510 is calculated as follows.

$${i}_{{L}^{=}} {i}_{L 1} + {i}_{L 2} + {i}_{L 3}$$

In this case, the size of the load resistor 1540a that is connected to one input stage of the amplifier 1520a to which the offset voltage is applied is implemented to be relatively small. The size of each of the load resistors 1540b and 1540c, each one connected to one input stage of each of the amplifiers 1520b and 1520c to which the voltage for frequency modulation and the PLL compensation voltage are applied, is implemented to be relatively large. As the load resistors 1540a to 1540n are implemented to have different sizes depending on the sizes of voltages applied thereto, respectively, as described above, noise within a current that occurs through the load resistor 1540 can be minimized, and the size of a current that flows into each load resistor can also be improved. Accordingly, the value of a current that flows into the load resistor 1540 is optimized. Power that is consumed in each load resistor 1540 is reduced because a current having an excessive size may not flow into any one load resistor 1540. Accordingly, the amount of heat generated from the apparatus can also b reduced.

As described above, the light source and the driving circuit within the light source driving circuit 310 do not operate voltages applied thereto by summing the voltages as in a conventional technology, but generate an individual current by applying each applied voltage to each load resistor having a size that complies with the applied voltage and sum and apply the currents to the laser diode 1510. Accordingly, the occurrence of noise can be minimized, and the generation of heat in the load resistor can also be minimized.

Furthermore, in FIG. 15, the offset voltage has been applied to one amplifier 1520a, one switch 1530a, and one load resistor 1540a. However, the light source and the driving circuit within the light source driving circuit 310 may distribute the offset voltage having a relatively high size and separately apply the distributed offset voltages to the plurality of amplifiers 1520, switches 1530, and load resistors 1540. Each amplifier 1520, switch 1530, and load resistor 1540 that are separated may also be implemented to have a structure in which currents generated by the respective load resistors are added, like the remaining amplifier 1520a to 1520n, switches 1530a to 1530n, and load resistors 1540a to 1540n. Accordingly, all of the currents that are generated by the respective load resistors may be added and applied to the laser diode 1510.

In this case, if the amplifier 1520a, the switch 1530a, and the load resistor 1540a are each separated into n in number, the separated load resistors are implemented to have composite resistance that is the same as the size of the load resistor 1540a. For example, assuming that the load resistor 1540a has a size R, the load resistor that is separated into n in number may have a resistance value “n*R”.

A problem in that the amount of heat generated is increased because a voltage (i.e., the offset voltage) having a relatively large size is applied to the load resistor can be solved, and the occurrence of noise can also be minimized.

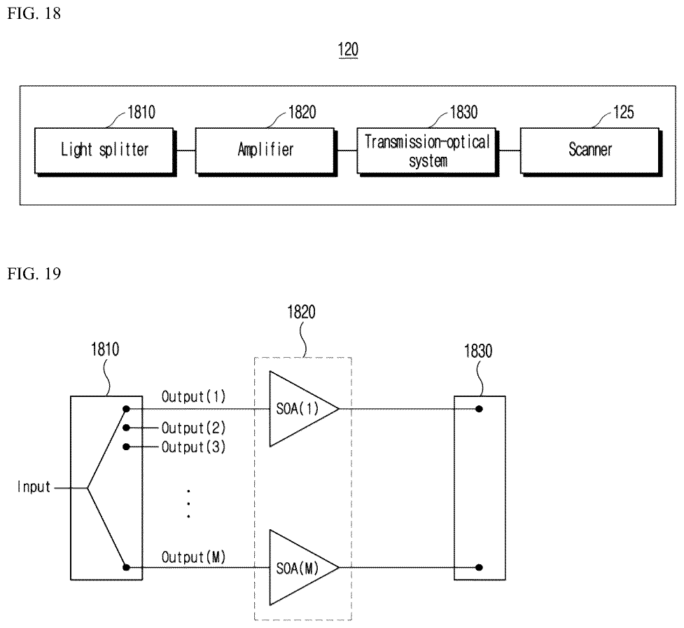

FIG. 18 is a diagram illustrating a construction of a light transmission unit according to an embodiment of the present disclosure. FIG. 19 is a diagram illustrating an implementation example of the light transmission unit according to an embodiment of the present disclosure.

Referring to FIGS. 18 and 19, the light transmission unit 120 according to an embodiment of the present disclosure includes a light splitter 1810, an amplifier 1820, and a transmission-optical system 1830. Furthermore, the light transmission unit 120 and/or the light reception unit 130 to be described later may further include a scanner 125.

The light splitter 1810 separates light that is output by the light source unit 110 into M pieces of light. As illustrated in FIG. 19, the light splitter 1810 may be implemented as an M:1 light splitter. Accordingly, the light splitter 1810 receives light that is output by the light source unit 110 and separates the light into the M pieces of light. The light splitter 1810 inputs the pieces of separated light to the amplifier 1820.

The amplifier 1820 amplifies the light that is thereon. The amplifier 1820 may be implemented as a semiconductor optical amplifier (SOA). In order to remove a resonator structure from the amplifier 1820, anti-reflection processing may be applied to both sides of the SOA. Accordingly, the amplifier 1820 amplifies light by induction emission by receiving the light from the outside. The amplifier 1820 may be implemented in the form of an SOA

array. The amplifier 1820 may constitute multiple channels with a low cost by being implemented in the form of the SOA array and amplifying multi-channel light, and may also maintain a coherent characteristic of light. The amplifier 1820 may be used as a high-speed scanner because the SOA has a low price and enables high-speed switching in view of its structure.

The amplifier 1820 may simultaneously drive all the channels, and may switch and drive all the channels sequentially/non-sequentially.

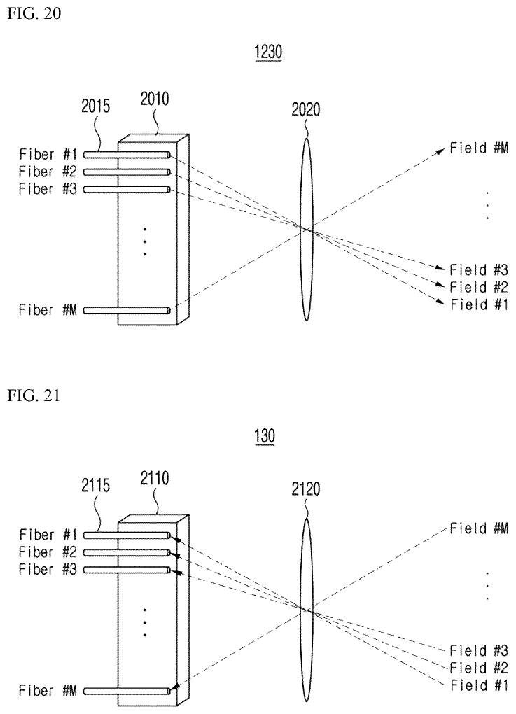

The transmission-optical system 1830 receives amplified light from the amplifier 1820 and transmits the amplified light to a detection area. The transmission-optical system 1830 may be implemented as illustrated in FIG. 20.

FIG. 20 is a diagram illustrating an implementation example of a transmission-optical system according to an embodiment of the present disclosure.

Laser light that has been amplified by the amplifier 1820 implemented in the form of the SOA array is input to an optical fiber array 2010 included in the transmission-optical system 1830. As illustrated in FIG. 20, M (the same as the number of pieces of light separated by the light splitter) optical fibers 2015 are disposed in parallel in the optical fiber array 2010 in a first direction (i.e., a direction perpendicular to a direction in which light proceeds). The M pieces of light that are output by the optical fibers 2015 within the optical fiber array 2010, respectively, may be output without any change, or may be transmitted to a detection area through other optical component 2020 that adjusts the light path of light.

If the light transmission unit 120 includes only the light splitter 1810, the amplifier 1820, and the transmission-optical system 1830, a LiDAR apparatus that scans light in the aforementioned first direction may be constructed. However, if the light transmission unit 120 further includes the scanner 125, a LiDAR apparatus that scans light in two dimensions may be constructed. The scanner 125 may scan light that is output in two dimensions by scanning the light in a second direction perpendicular to the first direction. In general, scanning in the second direction for two-dimensional scanning does not require high-speed driving because one-dimensional scanning can be driven at a very high speed in the first direction by the remaining components 1810 to 1830 of the light transmission unit 120. Accordingly, the scanner 125 that performs scanning in the second direction does not have special restrictions or requirements, and may be implemented as an arbitrary scanner.

FIG. 21 is a diagram illustrating a construction of a light reception unit according to an embodiment of the present disclosure.

Referring to FIG. 21, the light reception unit 130 includes an optical fiber array 2110 including M optical fibers. Reflected light that is reflected by a detection area or a target is input to M optical fibers 2115 within the optical fiber array 2110. The optical fiber array 2110 is aligned on the same line of sight (LOS) as the optical fiber array 2010, and has the same structure as the optical fiber array 2010 except a transmission direction.

The light reception unit 130 may further include other optical component 2120 so that reflected light that is reflected by a detection area or a target is input to each optical fiber 2115 within the optical fiber array 2110 more smoothly.

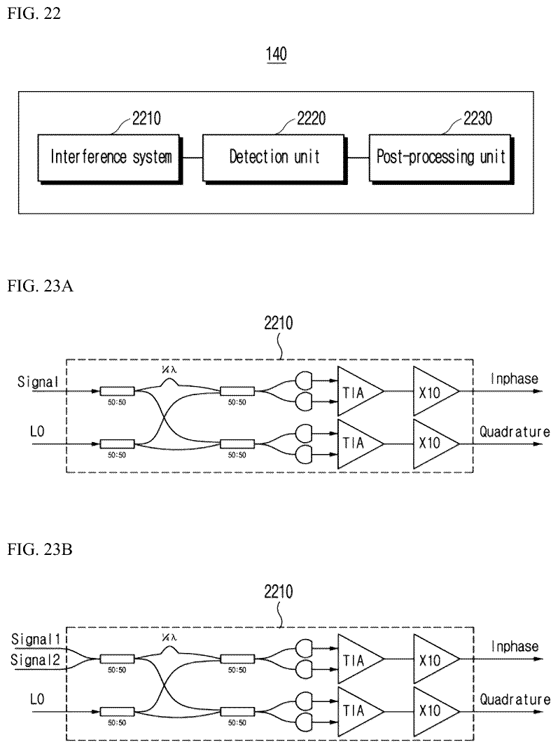

FIG. 22 is a diagram illustrating a construction of a signal processing unit according to an embodiment of the present disclosure.

Referring to FIG. 22, the signal processing unit 140 according to an embodiment of the present disclosure includes an interferometer 2210, a detection unit 2220, and a post-processing unit 2230.

The interferometer 2210 may include a complex signal interferometer having a 90-degree optical hybrid structure, and may have a form in which multiple complex signal interference system interferometers have been disposed in parallel. One implementation example of the interferometer 2210 has been illustrated in FIG. 23A or 23B.

FIG. 23 is a diagram illustrating an implementation example of an interferometer within the signal processing unit according to an embodiment of the present disclosure.

Referring to FIG. 23A, some of light that is generated by a coherent laser oscillator is branched and input to a local oscillator (LO) of the interferometer 2210. A signal (Signal) is very weak reflected light that is reflected by a target. It is very difficult to detect or impossible to detect the signal because the size of the signal is very small.

Accordingly, the interferometer 2210 makes the signal, that is, the weak reflected light, interfere with the LO, and amplifies the reflected light by an amplification effect that is generated by the interference so that the detection unit 2220 can easily detect the reflected light.

The interferometer 2210 generates an in-phase signal and a quadrature signal (i.e., a signal having a phase difference of 90 degrees from the in-phase signal) in order to generate a complex signal for the processing of a fast Fourier transform (FFT) signal and the demodulation of an amplitude modulation signal.

Referring to FIG. 23B, the interferometer 2210 may have two signal channels in order to efficiently construct a multi-channel structure. When two or more input signals are input to an interferometer simultaneously, in general, it is impossible to distinguish between the input signals because output signals are mixed. However, the interferometer 2210 may obtain input signals for two channels by using one interferometer having a 90-degree optical hybrid structure because a transmission channel for each input signal can switch in an output channel. Accordingly, costs for fabricating a reception channel can be generally reduced.

Referring back to FIG. 22, the detection unit 2220 detects reflected light (i.e., light) that has been amplified through the interferometer 2210.

The post-processing unit 2230 converts a signal that has been detected by the detection unit 2220 into a digital signal, and then obtains coordinate information of the target through post-processing.

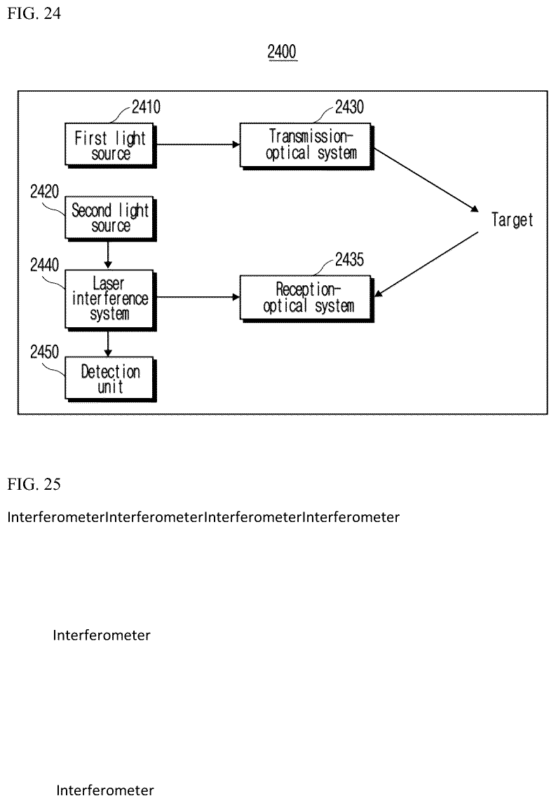

FIG. 24 is a diagram illustrating a construction of a Doppler LiDAR apparatus according to another embodiment of the present disclosure.

Referring to FIG. 24, a Doppler LiDAR apparatus 2400 “apparatus”) according to an (hereinafter abbreviated as an embodiment of the present disclosure includes first and second light sources 2410 and 2420, a transmission-optical system 2430, a reception-optical system 2435, a laser interferometer 2440, and a detection unit 2450.

The apparatus 2400 measures information on the speed of a target by using light having a plurality of wavelengths, more specifically, light having two wavelengths. The apparatus 2400 may measure information on the speed of a target by once radiating light, and may measure the speed of the target (i.e., a concept also including the directivity of the target) although the information does not include AOM.

The first and second light sources 2410 and 2420 make light for detecting a target oscillate by receiving a current.

The first light source 2410 outputs light having the characteristic illustrated in FIG. 3A in order to detect the speed of a target.

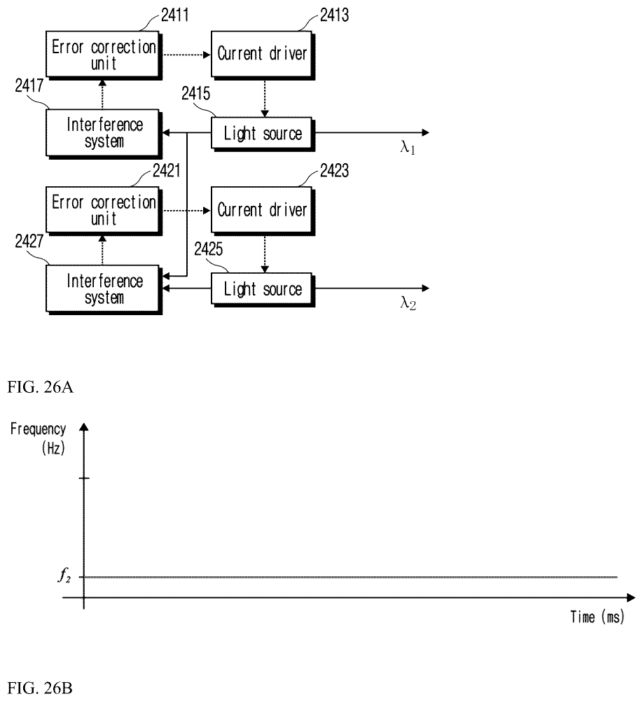

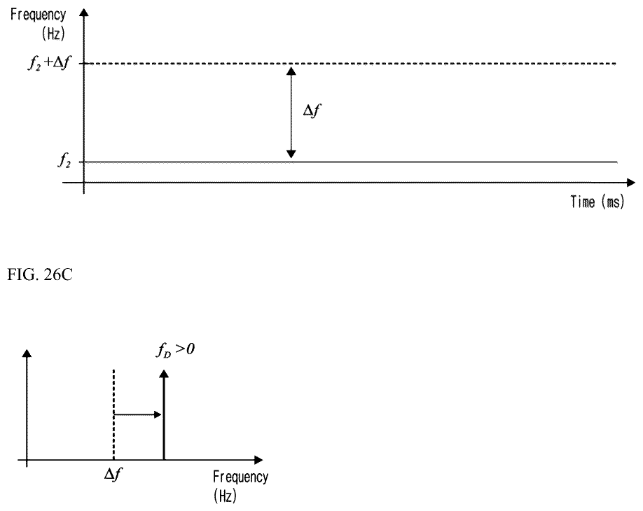

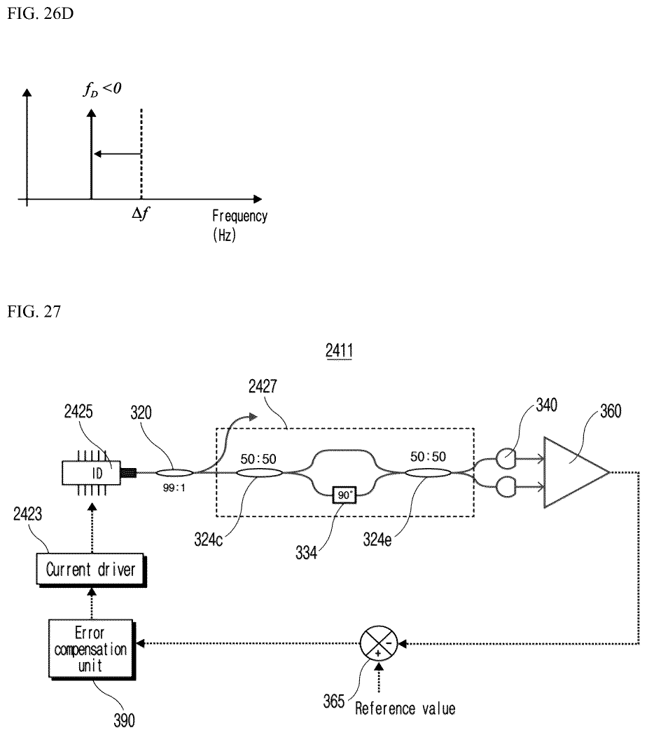

FIG. 26A is a graph illustrating the characteristics of a change in the frequency of light for each time, which is output by the first light source, according to another embodiment of the present disclosure.

Referring to FIG. 26A, the first light source 2410 outputs light having a predetermined frequency (f₁) so that the speed of a target can be measured by using a Doppler effect. If a Doppler frequency of light that is reflected by the target is f_{D}, the speed of the target may be calculated as follows.

$$v = \frac{{λ}_{0} Δ {f}_{d}}{2} = \frac{{λ}_{0} ( {f}_{D} - {f}_{2} )}{2}$$

In this case, v means the speed of the target. λ_{O} means the wavelength of the light that is output by the first light source 2410.

If the wavelength and frequency of the light radiated by the first light source 2410 and the Doppler frequency of the light reflected by the target are known through such a process, the speed of the target may be detected.

However, although the speed of the target is detected through the aforementioned process, it is difficult to check a direction in which the target moves. The target may be in a situation in which the target becomes distant at the corresponding speed or in a situation in which the target becomes close at the corresponding speed. This is conventionally detected by using AOM. However, the AOM includes various problems. For this reason, the apparatus 2400 includes the second light source 2420. The second light source 2420 outputs light having a characteristic illustrated in FIG. 26B.

FIG. 26B is a graph illustrating the characteristics of a change in the frequency of light for each time, which is output by the second light source, according to another embodiment of the present disclosure.

Referring to FIG. 26B, the second light source 2420 outputs light having a preset frequency difference (Δf) from the frequency (f₂) of the light that is output by the first light source 2410. In this case, the preset frequency difference may be a frequency within a preset error range on the basis of 50 MHZ. If light is output by only the first light source 2410, it is difficult to detect even the directivity of a moving target. In contrast, if light is output by the second light source 2420, as illustrated in FIGS. 26C and 26D, the directivity of the moving target may be detected along with a Doppler frequency that is reflected by the target.

FIGS. 26C and 26D are graphs illustrating the characteristics of a change in the frequency of reflected light for each time according to an embodiment of the present disclosure.

As illustrated in FIG. 26C, when a target becomes distant from the apparatus 2400, a Doppler frequency (f_{D}) greater than the frequency of output light is introduced. However, as illustrated in FIG. 26D, when the target becomes close to the apparatus 2400, the Doppler frequency (f_{D}) smaller than the frequency of the output light is introduced.

Referring back to FIG. 24, as described above, as the apparatus 2400 includes the second light source 2420, the apparatus 2400 may detect whole speed information including the directivity of a target at a time by using one detection unit.

The transmission-optical system 2430 adjusts the path or state of light so that light that is made oscillate by the first light source 2410 is radiated to a target.

The reception-optical system 2435 adjusts the path or state of reflected light that is reflected by a target. The reception-optical system 2435 adjusts the path of the reflected light so that the reflected light that is reflected by the target and then incident thereon proceeds to the laser interferometer 2440.

The laser interferometer 2440 receives the reflected light that has passed through the reception-optical system 2435 and the light that is radiated by the second light source 2420, and makes the reflected light and the light interfere with each other.

The detection unit 2450 detects information on the speed of a target by receiving light that has passed through the laser interferometer 158. As described above, the information on the speed of the target may be known based on the Doppler frequency (f_{D}). Accordingly, the detection unit 2450 may detect a Doppler frequency based on pieces of light that are input thereto, and may detect information on the speed of a target based on the pieces of light. In particular, the detection unit 2450 may detect whole information on the speed of a target including the directivity of the target even without a component, such as a separate AOM. The detection unit 2450 may detect a Doppler frequency based on reflected light that is incident thereon as illustrated in FIGS. 26C and 26D. In particular, the detection unit 2450 may easily detect the size and sign (+, −) of a Doppler frequency based on reflected light that is incident thereon via the reception-optical system 2435 because the detection unit 2450 receives light that has been made to oscillate from the second light source 2420.

According to the aforementioned process, the apparatus 2400 may detect both distance information and speed information through one calculation process, based on only a signal that has been detected by the one detection unit 2450.

FIG. 25 is a diagram illustrating a construction of a light source and a light path adjustment unit according to another embodiment of the present disclosure.

Referring to FIG. 25, the light sources 2410 and 2420 according to another embodiment of the present disclosure include error correction units 2411 and 2421, the current drivers 2413 and 2423, light sources 2415 and 2425, and interferometers 2417 and 2427.

The error correction units 2411 and 2421 each remove phase noise that is included in output light so that each of the light sources 2410 and 2420 may uniformly output the aforementioned frequency.

The current drivers 2413 and 2423 each apply, to each of the light sources 2415 and 2425, a current having an error corrected by each of the error correction units 2411 and 2421. The light sources 2415 and 2425 each uniformly output the aforementioned frequency by receiving the aforementioned current from each of the current drivers 2413 and 2423.

The light sources 2415 and 2425 each output light having a predetermined frequency by receiving a current from each of the current drivers 2413 and 2423.

The interferometer 2427 detects whether a difference between the frequencies of pieces of light output by the light sources 2415 and 2425 is constant by receiving some of the light that is output by the light sources 2415 and 2425. The interferometer 2427 is implemented as a component capable of comparing the frequencies of signals of the light sources 2415 and 2425, such as a 2×2 coupler, and detects whether the frequencies of light that is output by the light sources 2415 and 2425 maintain a preset frequency difference (Δf). If the frequencies of the light that is output by the light sources 2415 and 2425 does not maintain the preset frequency difference (Δf), the interferometer 2427 may detect an error and feed the error back to the current driver 2423 so that the frequencies of the light that is output by the light sources 2415 and 2425 maintain the preset frequency difference (Δf).

The interferometer 2417 detects phase noise included in light that is output by the light source 2415 by receiving the light that is output by the light source 2415. The interferometer 2417 may be implemented as illustrated in FIG. 27.

FIG. 27 is a diagram illustrating a construction of the error correction unit within the first light source according to another embodiment of the present disclosure.

Referring to FIG. 27, the error correction unit 2411 according to an embodiment of the present disclosure includes distributors 320 and 324 (324c and 324e), a phase delayer 334, a light reception unit 340, a mixer 360, a calculator 365, and an error compensation unit 390.

The distributor 320 distributes light that is output by the light source 2415 into light for detecting a target and light for frequency modulation linearization. The distributor 320 may distribute the light for detecting a target at a preset ratio, for example, 90% or more compared to the light for frequency modulation linearization. The light for detecting a target, which has been distributed by the distributor 320, may be branched into the transmission-optical system 2430 and radiated to the outside.

The light that has been branched for frequency modulation linearization by the distributor 320 is applied to the interferometer 2417. The interferometer 2417 makes the light applied thereto subjected to time delay or phase delay, and makes light that has not been delayed and light that has been subjected to time delay and/or phase delay interfere with each other.

The distributor 324c branches light that is applied to the interferometer 2417 at a ratio of 50:50. The phase of any one of two pieces of light that have been branched via the distributor 324c and that have been subjected to time delay is delayed by 90° through the phase delayer 334. The two pieces of light (i.e., the light having the phase delayed and the light having the phase not delayed) are incident on the distributor 324e and interfere with each other. The light reception unit 340 senses first interference light and second interference light as a first interference signal (or current signal) and a second interference signal (or current signal), respectively.

The pieces of interference light received by the light reception unit 340 are applied to and mixed by the mixer 740.

A signal that has been mixed by the mixer 360 is applied to the calculator 365. The calculator 365 receives the signal mixed by the mixer 740 and a signal having a uniform frequency (i.e., a reference signal). The calculator 365 may output a phase noise signal that is included in the signal mixed by the mixer 360 because the calculator 365 receives the reference signal having a uniform frequency. The calculator 365 outputs the phase noise signal to the error compensation unit 390.

The error compensation unit 390 converts the phase noise signal that has passed through the calculator 365 into a current signal so that the current driver 2413 may compensate for an error.

The current driver 2413 applies, to the light source 2415, a current having an error compensated for.

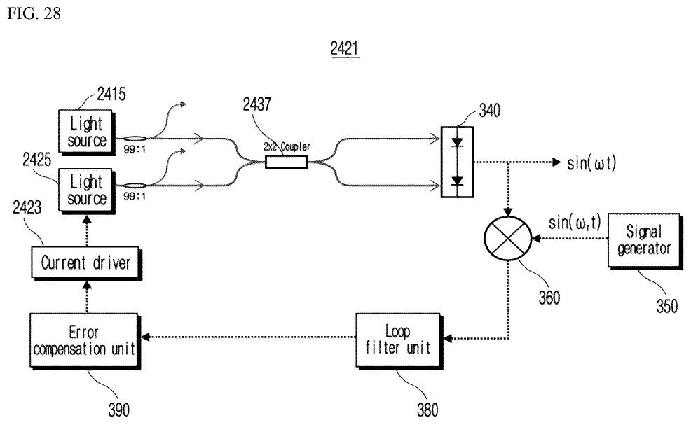

The interferometer 2427 detects whether a difference between the frequencies of the two pieces of light is constant by receiving the two pieces of light that are output by the light source 2415 and the light source 2425. The interferometer 2427 may be implemented as illustrated in FIG. 28.

FIG. 28 is a diagram illustrating a construction of the error correction unit within the second light source according to another embodiment of the present disclosure.

Referring to FIG. 28, the error correction unit 2421 according to an embodiment of the present disclosure includes a light reception unit 340, a signal generator 350, a mixer 360, a loop filter unit 380, and an error compensation unit 390. An operation of each of the components illustrated in FIG. 28 is the same as that of the error correction unit 2411, and a redundant description thereof is omitted.

The interferometer 2427 is implemented as a component capable of comparing the frequencies of two signals applied thereto, such as a 2×2 coupler, receives some of two pieces of light that are output by the light sources 2415 and 2425, and make the two pieces of light interfere with each other.

The signal generator 350 generates a reference signal having a frequency corresponding to a preset frequency difference (Δf) that needs to be owned by both the light sources 2415 and 2415.

The mixer 360 receives interference light received by the light reception unit 340 and the reference signal generated by the signal generator 350, and mixes the interference light and the reference signal.

The loop filter unit 380 filters out other noise by receiving the signal that has been mixed by the mixer 360.

The error compensation unit 390 converts a phase noise signal that has passed through the loop filter unit 380 into a current signal, and applies a current having an error compensated for to the current driver 2423. Accordingly, the current driver 2423 enables the frequency of the light that is output by the light source 2425 to maintain a preset difference from the frequency of the light that is output by the light source 2415.

The above description is merely a description of the technical spirit of the present embodiment, and those skilled in the art may change and modify the present embodiment in various ways without departing from the essential characteristic of the present embodiment. Accordingly, the embodiments should not be construed as limiting the technical spirit of the present embodiment, but should be construed as describing the technical spirit of the present embodiment. The technical spirit of the present embodiment is not restricted by the embodiments. The range of protection of the present embodiment should be construed based on the following claims, and all of technical spirits within an equivalent range of the present embodiment should be construed as being included in the scope of rights of the present embodiment.

What is claimed is:

1. A Doppler LiDAR apparatus comprising:
a plurality of light sources each configured to output light for detecting a speed of a target and a directivity of a moving target;
an optical system configured to adjust a path or state of light to be output to an outside or reflected light that is reflected by the target;
an interferometer configured to make the light that is output by any one of the plurality of light sources and the reflected light that has passed through the optical system interfere with each other; and
a detection unit configured to detect information on a distance and speed of the target by receiving the light that has been subjected to interference in the interferometer.

2. The Doppler LiDAR apparatus of claim 1, wherein the plurality of light sources comprises:
a first light source configured to output the light for detecting the speed of the target; and
a second light source configured to output the light for detecting the directivity of the moving target.

3. The Doppler LiDAR apparatus of claim 2, wherein the first light source detects the speed of the target by using a Doppler effect.

4. The Doppler LiDAR apparatus of claim 3, wherein the first light source outputs light having a uniform frequency.

5. The Doppler LiDAR apparatus of claim 2, wherein the second light source outputs light having a uniform frequency.

6. The Doppler LiDAR apparatus of claim 2, wherein the optical system comprises:
a transmission-optical system configured to adjust a path of the light that is output by the first light source so that the light proceeds to the target; and
a reception-optical system configured to adjust a path of the reflected light that is reflected by the target and that is incident from an outside so that the reflected light proceeds to the interferometer.

7. The Doppler LiDAR apparatus of claim 6, wherein the interferometer makes the light that has been output by the second light source and the reflected light that has passed through the reception-optical system interfere with each other.
